(19) United States
(12) Patent Application Publication
(10) Pub. No.: US 2012/0086286 A1
(43) Pub. Date: Apr. 12, 2012

(54) CYCLING LOAD CONTROLLER HAVING A LEARN MODE FOR AUTOMATICALLY DETERMINING WHEN THE LOAD IS TURNED ON AND OFF

(75) Inventor: Rodney D. Raabe, Swisher, IA (US)

(73) Assignee: Schneider Electric USA, Inc., Palatine, IL (US)

(21) Appl. No.: 12/902,234

(22) Filed: Oct. 12, 2010

(51) Int. Cl. H01H 9/54

(52) U.S. Cl. 307/140

(57) ABSTRACT

An electrical device to be used with an electrical load which is repetitively cycled on and off. The device includes a controllable switch for connecting the load to, and disconnecting the load from, the electrical power source; a device for detecting when the load is drawing power, and a memory module connected to the detecting device and with a controller coupled to the controllable switch. The memory module has selectable “learn” and “run” modes of operation. In the “learn” mode of operation the controller is programmed to detect and store the time and date when the load is drawing power, i.e. turned on; determine the average time of day the power was turned on;, and the average time between the turning on and off. During the “run” mode of operation, the module produces control signals for automatically turning the controllable switch on and off, thereby supplying power to the load, according to the schedule learned during the learn mode of operation, or a variant of the learned schedule.

### FIELD OF THE INVENTION

The present invention relates generally to electrical devices associated with the supplying of electrical power to loads that are repetitively cycled on and off. Examples of cycling loads are lighting, heaters, appliances, pools, hot tubs, air compressors, computer systems, audio equipment, ventilators or air handling equipment, fans, water softeners, security systems and electric cars.

### BACKGROUND

Programmable systems are known for controlling the delivery of power to electrical loads. But, with known systems, to control the electrical loads a program must still be prepared, or otherwise obtained, and implemented by the user.

### BRIEF SUMMARY

Discussion of the cycling load controller's component parts, or modules, will be given herein with respect to specific functional tasks or task groupings that are in some cases arbitrarily assigned to the specific modules for explanatory purposes. It will be appreciated by the person having ordinary skill in the art that aspects of the present invention may be arranged in a variety of ways, or that functional tasks may be grouped according to other nomenclature or architecture than is used herein without doing violence to the spirit of the present invention.

In various embodiments, a cycling load controller is an electrical device, or devices, that is used to control an electrical load which is repetitively cycled on and off when connected to an electrical power source. The cycle timing can be in minutes, hours, days, weeks, months including astronomical and utility off peak times. The device is placed in series with a load that cycles on a regular basis and learns when the load is on and off. There can be an internal current transformer that is used for monitoring lower amperage loads or terminals may be provided on the device for connection of an external current transformer for larger current loads. For higher voltage and higher amperage loads the module can be configured to control an electrical relay or an electrical contactor which in turn will control the cycling load.

The cycling load controller may contain a control screen connected to an electronic memory module. The control screen allows input of set-up information for the memory. This set up information consists of time, date, time zone and location. The control screen can contain an interface for operating modes comprising Manual operation mode, Learn mode, Run mode and an ON/OFF switch. The Manual mode allows manually programmed ON/OFF load commands including time shift to utility off-peak times. The Learn mode tracks the cycling load demand and programs the module cycle on and off times. The Run mode energizes and de-energizes the load according to the memory. The ON/OFF switch will turn all power on and off to the module.

One embodiment of the present disclosure provides an electrical device to be used with an electrical load to be repetitively cycled on and off when connected to an electrical power source. The device and its operation may provide an inexpensive means to add a layer of intelligence to energy consumption for devices heretofore powered on an instant demand basis of the device. Due to the cycling nature of demand by the load, however, the time of instant demand may not be the most desirable time to power the device. The device can include a controllable switch for connecting the load to, and disconnecting the load from, an electrical power source; a switch coupled to the controllable switch for turning the controllable switch on and off during a “learn” mode of operation; a controller coupled to the controllable switch; and a selector coupled to the controller for selecting the “learn” or “run” mode of operation. The controller is programmed to:
1. detect and store the time and date when the load draws power, i.e. is turned on and off, while in a “learn” mode of operation;
2. determine the average time of day when the load was turned on during the “learn” mode of operation, and the average time between the turning on and off of the load during the learn” mode of operation; and
3. produce control signals for automatically turning the controllable switch on and off during a “run” mode of operation by turning the controllable switch on at the average time of day when the controllable switch was turned on during the “learn” mode of operation, and by turning the controllable switch off after a time interval corresponding to the average time between the turning on and off of the controllable switch during the “run” mode of operation.

### BRIEF DESCRIPTION OF THE DRAWINGS

The foregoing and other advantages of the invention will become apparent upon reading the following detailed description and upon reference to the drawings.

FIG. 1 is a diagram of an automated system for controlling the supply of electrical power from a circuit breaker to cycling load.

FIG. 2 shows alternative aspects of the invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

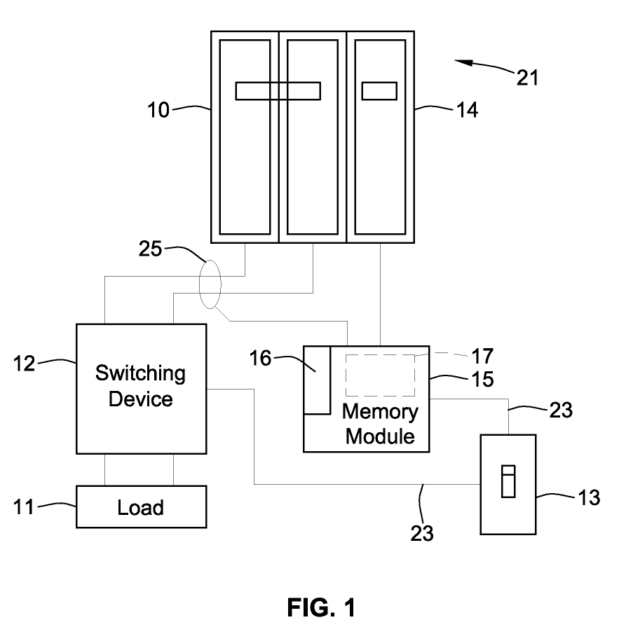

FIG. 1 illustrates a portion of a power distribution system in which electrical power is tracked and later controlled by a memory module 15. Power is supplied through a load center 21 having a high amperage two-pole circuit breaker 10 to supply power to a load 11 via controllable switching device 12. The switching device 12 is typically a relay or contactor, i.e., a type of relay which can be switched to control the supply of power to the load 11 and which can handle the high power required to directly drive a high amperage load, such as a motor. The switching device 12 is controlled by the memory module 15 through a conductor 23 which has a manual switch 13 therein. The memory module 15 is powered through a single-pole low amp circuit breaker 14, also in the load center 21. The memory module 15 includes a programmable controller 16 (such as a microprocessor) and a human interface such as a touch-screen display 17 accessible to a user. The load 11 may be any load that is repetitively cycled on and off. In this embodiment, as noted, the load is typically a high amperage load such as a bank of office lighting, heaters, appliances, pools, hot tubs, air compressors, computer systems, audio equipment, ventilators, air handling equipment, water softeners, security systems, electric cars, etc. When the manual switch 13 is closed, the memory module 15 is connected to the switching device 12 for controlling the power to the load 11, as discussed with respect to “run” mode, below.

The memory module 15 is connected to a device for monitoring the current draw by the load 11, such as a current transformer (CT) 25. The controller 16 in the memory module 15 may also send signals to, and receive signals from, the display 17 for interfacing with a user. The controller 16 may also monitor the status (on or off) of the switch 13, and the switching device 12. The memory module 15 includes a clock that supplies the controller 16 with time and date information.

To initially set up the memory module 15, the user can use the touch-screen display 17 to enter the required information in fields that call for the current time and date, whether the entered time is daylight savings time, and the desired mode of operation (“learn,” “run” or “manual”). In one aspect, with an appropriate application specific integrated circuit (ASIC), the latitude and longitude of the location may be entered to control lighting as the daily photoperiod adjusts with the seasons. In other aspects and embodiments, the memory module might merely track cycling from the time it is placed in learn mode.

In the “learn” mode, ordinary power transmission to the load 11 is not interfered with, and the microprocessor in the module 15 automatically detects power draw by the load 11 via the CT 25 and records the time and date of each such event. The module 15 may be set to only account for a power draw measuring above a certain wattage to take into account the parasitic power draw of the on board electronics of certain loads. All this information is stored in the memory as a log of the switching events that occur as long as the module 15 remains in the “learn” mode. When the “learn” mode is terminated, the controller 16 automatically retrieves the stored log and analyzes the data in the log to determine the average time of day when the switching device was switched on, the average time when the switching device was switched off, and the average time between those two events (e.g., whether more than one day). These results are stored in the memory for use in the “run” mode of operation.

When the “run” mode is selected, the controller 16 in the memory module 15 terminates the “learn” mode and automatically produces control signals to turn the switching device 12 on and off at the average times, and at the average time intervals, computed from the log of such events that occurred during the learn mode. Computing the average time interval between successive events enables the controller 16 to generate successive control signals at the same average time intervals that occurred during the learn mode even when those intervals were longer than one day. Thus, the module 15 automatically controls the switching device 12 to supply power to the load 11 in the same cyclic pattern recorded during the learn mode. Alternatively, the controller 16 can be programmed or otherwise activated to time shift the cyclic pattern to an “off peak” time period designated by power supplier, when electrical power is more readily available, and thus usually at a lower cost.

In the illustrative embodiment, the manual switch 13 must remain closed as long as the module 15 is in the “run” mode, to maintain the connection between the module 15 and the switching device 12. Alternatively, the controller 16 can be programmed to automatically close a controllable shunt switch to bypass the manual switch 13 when the run mode is selected.

In the “manual” mode, the user can use the touch-screen display 17 to set a new cycle, or to modify the cycle determined by the controller 16 at the end of a “learn” mode, by manually setting a desired time and date for the controller 16 in the module 15, e.g., to allow the load to operate only during an off peak time designated by the power company.

The controller 16 can be conveniently implemented using one or more general purpose computer systems, microprocessors, digital signal processors, micro-controllers, ASICs, programmable logic devices (PLD), field programmable logic devices (FPLD), field programmable gate arrays (FPGA), and the like, programmed according to the teachings as described and illustrated herein, as will be appreciated by those skilled in the computer and software arts.

The machine readable instructions in the program executed by the controller 16 can be embodied in software stored on tangible media such as, for example, a flash memory, but persons of ordinary skill in the art will readily appreciate that the entire algorithm and/or parts thereof could alternatively be executed by a device other than a processor and/or embodied in firmware or dedicated hardware in a well-known manner (e.g., it may be implemented by an application specific integrated circuit (ASIC), a programmable logic device (PLD), a field programmable logic device (FPLD), a field programmable gate array (FPGA), discrete logic, etc.). For example, any or all of the components of the controller 16 could be implemented by software, hardware, and/or firmware.

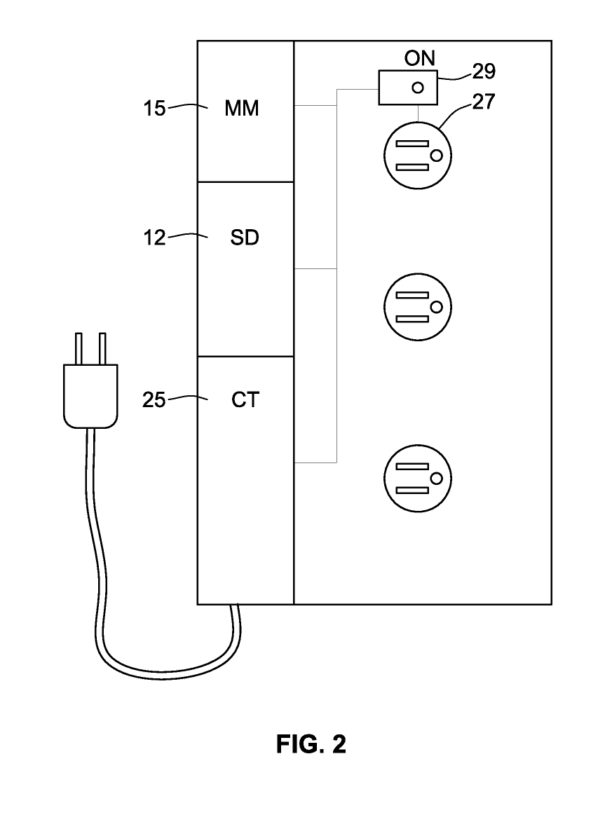

Referring to FIG. 2, in other aspects of the invention, a memory module 15, power monitor 25 and controllable switching device 12 may be incorporated according to the principles of the invention into a free standing device such a plug strip 27 with one receptacle 27 being for a cycling load control when selected as such by an on/off switch 29. The plug strip 27 is of course for use at a circuit breaker protected electrical outlet (not shown) of the user's choosing and naturally placed between the protected power line and the load connected thereto.

While the present invention has been described with reference to one or more particular embodiments, those skilled in the art will recognize that many changes can be made thereto without departing from the spirit and scope of the present invention. Each of these embodiments and obvious variations thereof is contemplated as falling within the spirit and scope of the claimed invention, which is set forth in the following claims.

1. A method of supplying electrical power to a load that is repetitively cycled on and off by a controllable switch, said method comprising
a. selecting a “learn” mode of operation and supplying power to said load in desired time periods during said “learn” mode of operation,
i. detecting and storing the time and date when said power is drawn by said load,
ii. determining an average time of day when said power was drawn by said load during said “learn” mode of operation, and the average length of said time periods during which power was drawn by said load during said “learn” mode of operation, and
b. selecting a “run” mode of operation and producing control signals for automatically supplying power to said load during said “run” mode of operation at times corresponding to said average times, and for periods corresponding to said average length of time.

2. The method of claim 1 which includes monitoring the electrical current drawn by said load.

3. The method of claim 1 in which said “learn” and “run” modes of operation are manually selected.

4. The method of claim 1 which includes time shifting said average times determined for said “learn” mode of operation to an “off peak” time period in which electrical power is more readily available.

5. The method of claim 1 which includes a controllable switch for controlling the supply of power to said load.

6. An electrical device to be used with an electrical load to be repetitively cycled on and off when connected to an electrical power source, said device comprising
a. an electrical current monitor for monitoring the current drawn by said load from said electrical power source;
b. a controller coupled to said monitor and programmed to:
i. detect and store the time and date when, and the time periods during which, said power is drawn by said load in a “learn” mode of operation,
ii. determine an average time of day when, and the average length of said time periods during which, power was drawn by said load during said “learn” mode of operation, and
iii. to produce control signals for automatically supplying power to said load, at said average times of day, and during said average time periods, during a “run” mode of operation, and
c. a selector coupled to said controller for selecting the “learn” or “run” mode of operation.

7. The electrical device of claim 6 in which said controller is programmed to determine the average time of day when power was drawn by said load during said “learn” mode of operation.

8. The electrical device of claim 6 which includes a controllable switch for connecting the load to, and disconnecting the load from, said electrical power source.

9. The electrical device of claim 8 which includes a manually operated switch coupled to said controllable switch for turning said controllable switch on and off during a “learn” mode of operation.

10. The electrical device of claim 9 in which said manually operable switch connects said controller to said controllable switch.

11. The electrical device of claim 6 in which said controller can be programmed to time shift said average times determined for said “learn” mode of operation to an “off peak” time period in which electrical power is more readily available.
